(19) United States
(12) Patent Application Publication
(10) Pub. No.: US 2024/0364432 A1
(43) Pub. Date: Oct. 31, 2024

(54) SYSTEMS AND METHODS FOR TRAINING AND VALIDATION OF MACHINE-LEARNING-BASED RF TRANSMIT/RECEIVE SYSTEMS

(71) Applicant: Tektronix, Inc., Beaverton, OR (US)

(72) Inventors: Christopher N. White, Beaverton, OR (US); Alexander Krauska, Beaverton, OR (US); Alejandro C. Buritica, Georgetown, TX (US)

(21) Appl. No.: 18/643,943

(22) Filed: Apr. 23, 2024

Related U.S. Application Data
(60) Provisional application No. 63/462,511, filed on Apr. 27, 2023.

(51) Int. Cl. H04B 17/00; H04B 17/10; H04B 17/15

(52) U.S. Cl. CPC H04B 17/0085; H04B 17/101; H04B 17/191

(57) ABSTRACT

A test and measurement device includes a signal generator to generate a test signal, a signal analyzer to receive a response signal from an adaptive system under test (SUT), communications ports to allow reception of the response signal, and one or more processors to send a signal to the signal generator to generate a first test signal, receive a response signal from the signal analyzer, measure performance of the response signal, and report the performance to at least one of the SUT and a user workspace on the test and measurement device. A method of testing a system under test (SUT) includes generating and sending a test signal with a signal generator, receiving a response signal from the SUT at a signal analyzer, measuring performance of the response signal with respect to the test signal, and reporting the performance to at least one of the SUT and a user workspace.

### CROSS-REFERENCE TO RELATED APPLICATIONS

This disclosure is a non-provisional of and claims benefit from U.S. Provisional Application No. 63/462,511, titled “SYSTEMS AND METHODS FOR TRAINING AND VALIDATION OF MACHINE-LEARNING-BASED RF TRANSMIT/RECEIVE SYSTEMS,” filed on Apr. 27, 2023, the disclosure of which is incorporated herein by reference in its entirety.

### TECHNICAL FIELD

This disclosure relates to test and measurement systems, and more particularly to a test system and test methods and systems for training and validating operation of a machine-learning-based transmit/receive system.

### BACKGROUND

Many transmit and receive systems, such as communications systems and radio frequency (RF) systems, including radar, require the ability to dynamically adapt or respond to the current state of their signal environment to maximize their application specific functional requirements and metrics of performance. Examples may include communications data throughput, radar jamming effectiveness, dynamic spectrum allocation, interference avoidance, and others.

These transmit and receive systems are often referred to as “adaptive” or “cognitive,” and are very often enabled by machine learning (ML) algorithms (broadly “artificial intelligence (AI)/ML”) that offer statistically robust models for decision making under both known and unknown operating conditions.

One specific example of these transmit and receive systems may be an adaptive transmit and receive system sensing the interfering traffic or jamming signals within their frequency range of operation and responding in a way that maintains sufficient data rates. The adaptive system may respond by adjusting the frequency of operation to a clear channel, adjusting power, or utilizing different modulation schemes to maximize sound-to-noise ratio (SNR), or including more protocol-level adaptations like allocating a higher percentage of packet data to error correction.

U.S. Pat. No. 11,047,957 describes one approach of testing and validating the machine learning decision logic in an RF system. That approach applies the evaluation of the performance of the response of the receiving device alone. The approach does not take into account the effectiveness of the application of response in the electromagnetic context of the received signal that caused the response.

### BRIEF DESCRIPTION OF THE DRAWINGS

FIG. 1 shows an embodiment of a test system for an adaptive transmit and receive system.

FIG. 2 shows an embodiment of a test instrument used for testing and evaluating performance of a transmit and receive system.

FIG. 3 shows a flowchart of an embodiment of testing a transmit and receive system.

### DETAILED DESCRIPTION

The effectiveness of bi-directional systems, bi-directional in that they transmit and receive, that include adaptive functionality should be validated at two primary levels. This especially applies to systems in which the adaptive functionality comes from machine learning such as a deep neural network (DNN). This discussion will refer to the transmit and receive systems as “adaptive systems,” as the test system evaluates the ability of the adaptive system to adapt to the incoming signal and the environment in which the adaptive system operates. The adaptive system may take many forms, including radio frequency (RF) systems, such as communications systems, radar systems, light detection and ranging (LIDAR), communications systems using an embedded physical (PHY) layer model in an Ethernet environment, etc.

The first level of validation validates the ability of the receiver system and machine learning system to properly detect the signal and identifies the type and characteristics of the incoming signal. Rejecting signal impairments from the received environment improves the ability of the adaptive system to correctly discern the incoming signal. The ability to discern the incoming signal depends on the ability of the algorithm to overcome a combination of the signal characteristics, the impairments from the received environment, and impairments from the adaptive system's receive chain. These three sub-steps within the first level may be considered “detect,” “identify parameters,” “reject impairments.” This first step may consist of any or all of these three sub-steps.

The second level of validation validates the effectiveness of the response selection portion of the adaptive system operating logic, which includes selection of the most effective parameters for response as measured by the adaptive system's ability to maximize operational figures of merit (data rate, jamming effectiveness, etc.). That is, this level of validation is a way to validate the effectiveness of the application “intelligence” of the artificial intelligence (AI)/machine learning (ML)-based adaptive system, also referred to as the System Under Test (SUT). The form of validation result may be a matrix, a vector of real or complex values, a scalar, or a simple “pass”/“fail” digital result.

As a result of the bi-directional nature of these adaptive transmit and receive systems, training the adaptive system's decision logic and validating the performance quality of the SUT require both the ability to stimulate the SUT and to receive the SUT response to determine the effectiveness of both stages noted above. This ability is distinct from U.S. Pat. No. 11,047,957, which focuses on radar object detection and uses the classification at the output of the machine learning algorithm in the receiving device as the final determinant of performance. In operation, however, the quality of performance of the adaptive functionality in these adaptive systems includes the quality of the SUT response, which requires the ability to receive the response of the SUT and evaluate the SUT's application-specific performance characteristics. This evaluation requires a training and validation system that includes both stimulus and response functionality.

The response by the radio, communications, radar, electronic countermeasure (ECM), or other type of SUT depends on the specific characteristics of the environment in which the SUT operates, referred to here as “electromagnetic (EM) context.” The objective effectiveness of the SUT includes the transmission of the response signal as measured at the physical (or simulated) point of the signal's intended generation, which includes the ability to overcome the characteristics of the current EM context of the response. The SUT response is validated at the point of delivery of its response, where the responding transmission signal is received, and by validating the operation of the algorithm that determines an appropriate response. As part of the first level “remove impairments” step, the impairments themselves may be extracted as a parameter (which may be in the form of a matrix, vector, scalar real or complex values) and presented to the second level effectiveness evaluation.

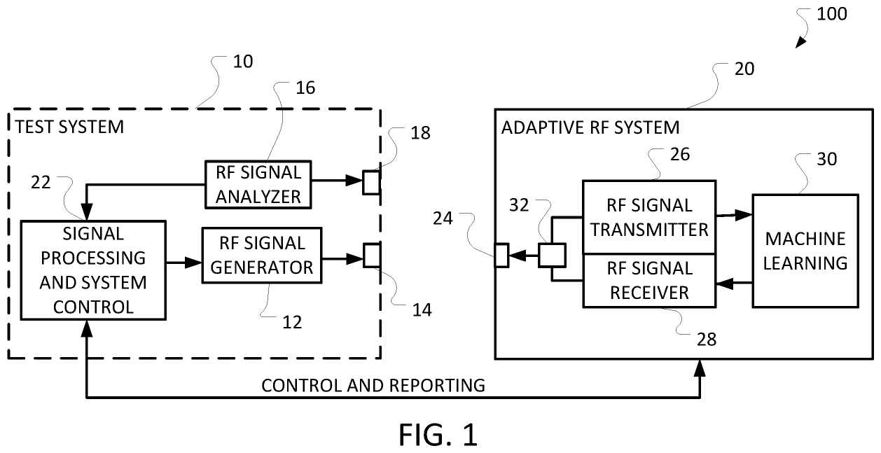

FIG. 1 shows an example of a test system configuration 100 according to embodiments of the disclosure. In this example, the transmit and receive system 100 is an RF system. System 100 has a test and measurement device 10 and an adaptive system as the SUT 20. Test and measurement device 10 includes signal analyzer 16, signal generator 12, and signal processing and system control unit 22. The test system 100 may be embodied in one or more separate test and measurement instruments or may comprise one test and measurement instrument that contains the above elements in a single housing. For case of discussion, either of these embodiments are referred to here as a test and measurement device or instrument as the test and measurement instrument 10. The test and measurement device 10 may include one or more communication ports, such as communication ports 18 and 14. The signal generator 12 and signal analyzer 16 may use a common communication port or may each have their own port, as illustrated in FIG. 1. For RF systems, the communication ports 14 and 18 may comprise antennas.

The SUT 20 may take many forms, and the test and measurement device 10 may interact with many different types of SUTs. No limitation to any adaptive system is intended, nor should any be inferred. The below discussion may refer to system 100 as an adaptive RF system for case of discussion, but the embodiments apply to all types of adaptive transmit and receive systems. In FIG. 1, the exemplary SUT 20 has a signal transmitter 26 and a receiver 28, connected to a communication port 24 through a signal conditioning unit 32. The transmitter 26 and receiver 28 are connected to a machine learning system 30, such as a deep learning network.

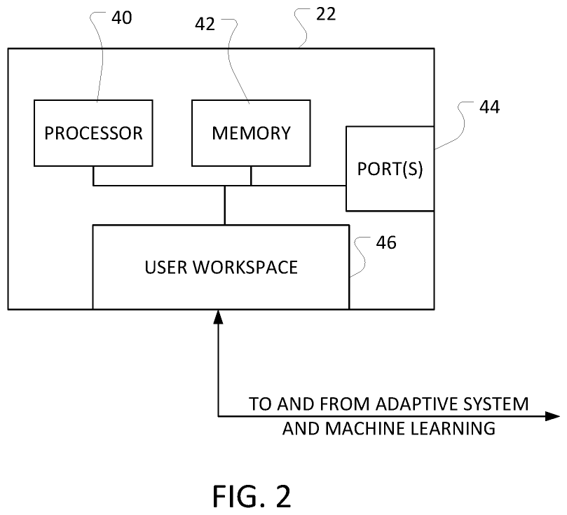

FIG. 2 shows an embodiment of the signal processing system and control unit 22 of the test and measurement device 10. The signal processing and system control unit 22 includes a memory 42, a processor 40, and one or more communications port 44. The communication ports 44 may connect with the signal analyzer 16 and the signal generator 12 and may include direct connection to SUT 20 shown in FIG. 1. The test and measurement device 10 may include a user workspace 46. The user workspace 46 may have a connection to the adaptive SUT 20 outside of any over-the-air communications between the antennas. The user workspace 46 may take many forms, including just a partition or other segment of the memory, a dedicated memory, or a memory 42 combined with some processing resources. Examples of such a user workspace 46 may include a development environment such as Visual Studio®, LabVIEW®, MATLAB®, or the like that runs on the test and measurement instrument. The user or the test and measurement instrument provider can develop the logic and parameters to determine the pass/fail decision for execution of the test.

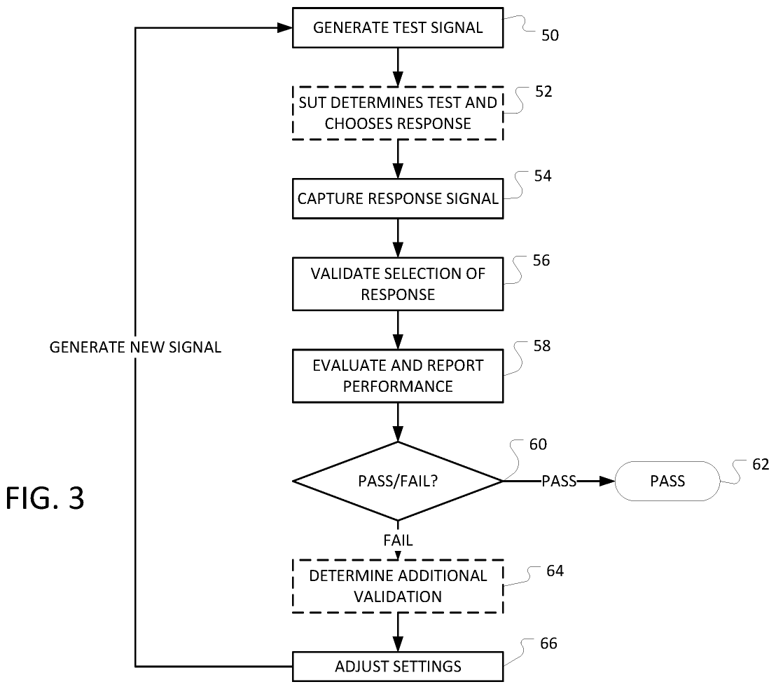

Using this testing system, FIG. 3 shows one embodiment of a method of performing the training or validation process. Test and measurement device 10 from FIG. 1 generates a “test signal” at 50 that may comprise radar, communication, or a jamming signal, among many others. In response, the SUT 20 detects and identifies the parameters and characteristics of the test signal and chooses an appropriate response signal at 52. In the case of a radar signal, the response from the SUT 20 may comprise a countermeasure, or electronic countermeasure (ECM) signal. The SUT 20 responds to the test signal by transmitting a response signal, such as a jamming signal to defeat the test signal, or other avoidance mechanism to avoid interference, etc. Note that the processes within the method designated with dashed lines indicate the processes performed by the SUT 20, or by the SUT 20 and/or the test and measurement device 10.

The test and measurement device 10 then captures the response signal at 54 at the signal analyzer 16. The test and measurement device 10, via the one or more processors 40 in the test and measurement device 10 or within the signal analyzer 16, then validates the selection of the countermeasure signal at 56. This validation at 56 may include comparing the response signal to the test signal to determine appropriateness of the response signal. The test and measurement device 10 also evaluates the performance of the SUT 20 based upon the response signal at 58. The performance parameters measured may include power, bandwidth, frequency, pulse shape, among many others and are evaluated against desired performance parameters. If the SUT 20 has met the performance measures at 60, the system passes at 62 and the test ends.

The test and measurement device 10 may send the report to the SUT 20, or to the user workspace 46 on the test and measurement device 10. The test and measurement device 10 or the SUT 20 may then analyze the response signal and decide whether the response signal was sufficient in light of the test signal. This determination may include a finding that the machine learning system 30 of FIG. 2 needs more training or needs testing on a different test signal at 64. This determination may involve the test and measurement device 10 making recommendations to the user, or directly working in the user workspace 46 to manage the training and validation sequence. The test and measurement device 10 or the SUT 20 may specify settings for the new test signal. The test and measurement device 10 then adjusts setting as needed to cause the signal generator to generate the new test signal at 66.

In this manner, the performance of and adaptive SUT undergoes evaluation not just based on its reception performance but in view of the transmitted test signal. This ensures that the machine learning system that provides the response to the test signal has sufficient information to allow for the most accurate response.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a test and measurement device, comprising: a signal generator to generate a test signal; a signal analyzer to receive a response signal from an adaptive system under test (SUT); one or more communications ports to allow reception of the response signal; and one or more processors to configured to execute code that causes the one or more processors to: generate a signal to the signal generator to cause the signal generator to generate a first test signal; receive a response signal from the signal analyzer; measure performance of the response signal with respect to the first test signal; and report the performance to at least one of the SUT and a user workspace on the test and measurement device.

Example 2 is the test and measurement device of Example 1, wherein the code that causes the one or more processors to send a signal to the signal generator causes the one or more processors to send settings for the first test signal to the signal generator.

Example 3 is the test and measurement device of either of Examples 1 or 2, wherein the settings comprise one or more of power level, pulse width, pulse rate, frequency response, and coding.

Example 4 is the test and measure device of any of Examples 1 through 3, wherein the code that causes the one or more processors to measure the performance comprises code that causes the one or more processors to measure one or more of power, bandwidth, frequency, and pulse shape.

Example 5 is the test and measurement device of any of Examples 1 through 4, wherein the one or more processors are further configured to execute code to cause the one or more processors to receive a message from the SUT requesting a second test signal and signaling readiness of the SUT for receipt of the second test signal.

Example 6 is the test and measurement device of Example 4, wherein the one or more processors are further configured to adjust settings of the signal generator prior to sending the second test signal.

Example 7 is the test and measurement device of any of Examples 1 through 6, wherein the one or more processors are further configured to execute code to cause the one or more processors to analyze the response signal and determine settings for a second test signal.

Example 8 is the test and measurement device of any of Examples 1 through 7, wherein the one or more communication ports include a control interface to the SUT.

Example 9 is the test and measurement device of Example 8, wherein the user workspace is accessible from the control interface.

Example 10 is the test and measurement device of any of Examples 1 through 9, further comprising one or more antennas connected to the one or more communications ports.

Example 11 is a method of testing an adaptive system under test (SUT), comprising: generating and sending a test signal with a signal generator of a test and measurement instrument; receiving a response signal from the SUT at a signal analyzer of the test and measurement instrument; measuring performance of the response signal with respect to the test signal; and reporting the performance to at least one of the SUT and a user workspace on the test and measurement device.

Example 12 is the method of Example 11, wherein generating and sending a test signal with the signal generator comprises determining settings for the signal generator.

Example 13 is the method of Example 12, wherein the settings comprise one or more of power level, pulse width, pulse rate, frequency response, and coding.

Example 14 is the method of any of Examples 11 through 13, wherein measuring the performance comprises measuring one or more of power level, pulse width, frequency response, and coding.

Example 15 is the method of any of Examples 11 through 15, further comprising receiving a message from the SUT requesting a second test signal.

Example 16 is the method of Example 15, wherein the message includes new settings for the second test signal.

Example 17 is the method of any of Examples 11 through 16, further comprising analyzing the response signal and determining settings for a second test signal within the user workspace on the test and measurement device.

Example 18 is the method of any of Examples 11 through 17, wherein receiving the response signal comprises receiving an over-the-air signal or receiving a connected signal.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific examples of the invention have been illustrated and described for purposes of illustration, it will be understood that various modifications may be made without departing from the spirit and scope of the invention. Accordingly, the invention should not be limited except as by the appended claims.

1. A test and measurement device, comprising:
a signal generator to generate a test signal;
a signal analyzer to receive a response signal from an adaptive system under test (SUT);
one or more communications ports to allow reception of the response signal; and
one or more processors to configured to execute code that causes the one or more processors to:
generate a signal to the signal generator to cause the signal generator to generate a first test signal;
receive a response signal from the signal analyzer;
measure performance of the response signal with respect to the first test signal; and
report the performance to at least one of the SUT and a user workspace on the test and measurement device.

2. The test and measurement device as claimed in claim 1, wherein the code that causes the one or more processors to send a signal to the signal generator causes the one or more processors to send settings for the first test signal to the signal generator.

3. The test and measurement device as claimed in claim 2, wherein the settings comprise one or more of power level, pulse width, pulse rate, frequency response, and coding.

4. The test and measure device as claimed in claim 1, wherein the code that causes the one or more processors to measure the performance comprises code that causes the one or more processors to measure one or more of power, bandwidth, frequency, and pulse shape.

5. The test and measurement device as claimed in claim 1, wherein the one or more processors are further configured to execute code to cause the one or more processors to receive a message from the SUT requesting a second test signal and signaling readiness of the SUT for receipt of the second test signal.

6. The test and measurement device as claimed in claim 4, wherein the one or more processors are further configured to adjust settings of the signal generator prior to sending the second test signal.

7. The test and measurement device as claimed in claim 1, wherein the one or more processors are further configured to execute code to cause the one or more processors to analyze the response signal and determine settings for a second test signal.

8. The test and measurement device as claimed in claim 1, wherein the one or more communication ports include a control interface to the SUT.

9. The test and measurement device as claimed in claim 8, wherein the user workspace is accessible from the control interface.

10. The test and measurement device as claimed in claim 1, further comprising one or more antennas connected to the one or more communications ports.

11. A method of testing an adaptive system under test (SUT), comprising:
generating and sending a test signal with a signal generator of a test and measurement instrument;
receiving a response signal from the SUT at a signal analyzer of the test and measurement instrument;
measuring performance of the response signal with respect to the test signal; and
reporting the performance to at least one of the SUT and a user workspace on the test and measurement device.

12. The method as claimed in claim 11, wherein generating and sending a test signal with the signal generator comprises determining settings for the signal generator.

13. The method as claimed in claim 12, wherein the settings comprise one or more of power level, pulse width, pulse rate, frequency response, and coding.

14. The method as claimed in claim 11, wherein measuring the performance comprises measuring one or more of power level, pulse width, frequency response, and coding.

15. The method as claimed in claim 11, further comprising receiving a message from the SUT requesting a second test signal.

16. The method as claimed in claim 15, wherein the message includes new settings for the second test signal.

17. The method as claimed in claim 11, further comprising analyzing the response signal and determining settings for a second test signal within the user workspace on the test and measurement device.

18. The method as claimed in claim 11, wherein receiving the response signal comprises receiving an over-the-air signal or receiving a connected signal.
